(19) United States
(12) Patent Application Publication
(10) Pub. No.: US 2008/0307436 A1
(43) Pub. Date: Dec. 11, 2008

(54) Distributed publish-subscribe event system with routing of published events according to routing tables updated during a subscription process

(75) Inventor: Keith S. Hamilton, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/810,530

(22) Filed: Jun. 6, 2007

(51) Int. Cl. G06F 3/00

(52) U.S. Cl. 719/318

(57) ABSTRACT

A publish-subscribe event system for a set of communicating machines, where when a machine receives an event, whether a published event or a subscription event, it publishes locally the received event by an inter-process communication in the machine. In this way, the event is made available to other processes on the machine. For some embodiments, an event is published locally in a machine by placing it in shared memory. During a subscription process, each machine updates its routing table as subscription events are received. When a published event is received by a machine, it is published locally by the inter-process communication in the machine, where the one or more subscribing applications on the machine may have access to it. The received published event is also routed to other connected machines according to the machine's routing table. Other embodiments are described and claimed.

### BACKGROUND

In a publish-subscribe system, a publisher running on a computer system sends out one or more messages when a specified event occurs, and a subscriber running on another computer system, or perhaps the same computer system as the publisher, receives published messages to which it has subscribed. A message sent by the publisher in response to some specific event is referred to as a published event. When a subscriber initiates a subscription, it sends out a message to indicate what type of published events it is subscribing to. This type of message sent by the subscriber is referred to as a subscription event.

A simple example of a publish-subscribe system may be provided within the context of providing timely stock quotes of publicly traded corporations. Suppose publisher P is to generate a published event if the stock price of corporations A, B, or C, has changed, where the published event gives the particular corporate name and its current stock price. Suppose subscriber S has subscribed to any published event for corporation B that indicates a change in its stock price. Then, when the event of a new stock price for corporation B occurs, a published event is sent by publisher P and is received by subscriber S. Other examples include news feeds, and auction and trading systems, to name just two.

Publish-subscribe technology allows processes to communicate with each other asynchronously across multiple machines, as well as between multiple executing processes running on the same machine. It is an asynchronous paradigm because there need not be any synchronization process set up between a publisher and a subscriber. This may be desirable for enterprise web applications. For example, a web farm may be viewed as a virtualized system, where system resources are shared among one or more processes. As a particular example, it may be useful for a cache to span multiple applications running in the web farm, and to span multiple machines in the web farm. A distributed cache is an example where a publish-subscribe event system may be of utility to synchronize the contents of the multiple caches across machines.

Software applications are also becoming more virtualized, meaning that the front-end part of applications may be dynamically instantiated across many servers, so as to scale in order to support usage demands. In a web farm, for example, there may be front-end components residing on web servers that send published events to a back-end component to correlate and process events. As a specific example, the behavior of a dynamic web site may be driven by a back-end recommendation system. In this case, the front-end web components send published events to the back-end recommendation engine which provides the recommendations back to the front-end components.

Another common scenario for web applications is metric collection. In this case, it is desirable to track all user activity at a web site. The activity metrics feed into a so-called business intelligence system, and are used for web site personalization, campaign management, and web site improvements.

A publish-subscribe system may be useful in the above discussed scenarios. Often, a publish-subscribe system is implemented by utilizing a broker to handle subscriptions and to deliver published events to the appropriate subscribers, where a broker is an intermediary program. However, the use of a broker in some instances may not provide high enough performance, and may introduce unacceptable latency.

### SUMMARY

An embodiment implements a publish-subscribe event process on a machine, where a machine may be a router, for example. According to an embodiment, when a subscription event is received at a machine, or initiated by the machine, the subscription event is published locally in the machine by an inter-process communication in the machine, so that the subscription event is made available to other processes on the machine. This inter-process communication may be implemented as shared memory on some embodiments, so that a subscription event may be published locally by placing it in shared memory.

A subscription event identifies published events to which it is subscribing by using an event type, referred to as a subscribed-to event type. If the subscription event was received over a communication channel, a routing table is updated to associate the subscribed-to event type of the subscription event with the communication channel over which it was received, and the subscription event is forwarded over other communication channels, excluding the communication channel over which it was received. If the subscription event was initiated by the machine itself, it is forwarded over all communication channels unless the subscription is marked as local-only.

According to an embodiment, when a published event is received at the machine, it is published locally by the inter-process communication in the machine so that all subscribing applications running on the machine that subscribe to the published event may have access to it. The published event is forwarded to other machines according to the routing table built up during the subscription process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates processes running on a machine according to an embodiment of the present invention.

FIG. 2 illustrates a hierarchical topology of machines according to an embodiment of the present invention.

FIG. 3 illustrates a topology of machines according to another embodiment of the present invention.

FIG. 4 illustrates a flow diagram according to an embodiment of the present invention.

FIG. 5 illustrates a computer system running processes according to an embodiment of the present invention.

### DETAILED DESCRIPTION

In the description that follows, the scope of the term “some embodiments” is not to be so limited as to mean more than one embodiment, but rather, the scope may include one embodiment, more than one embodiment, or perhaps all embodiments.

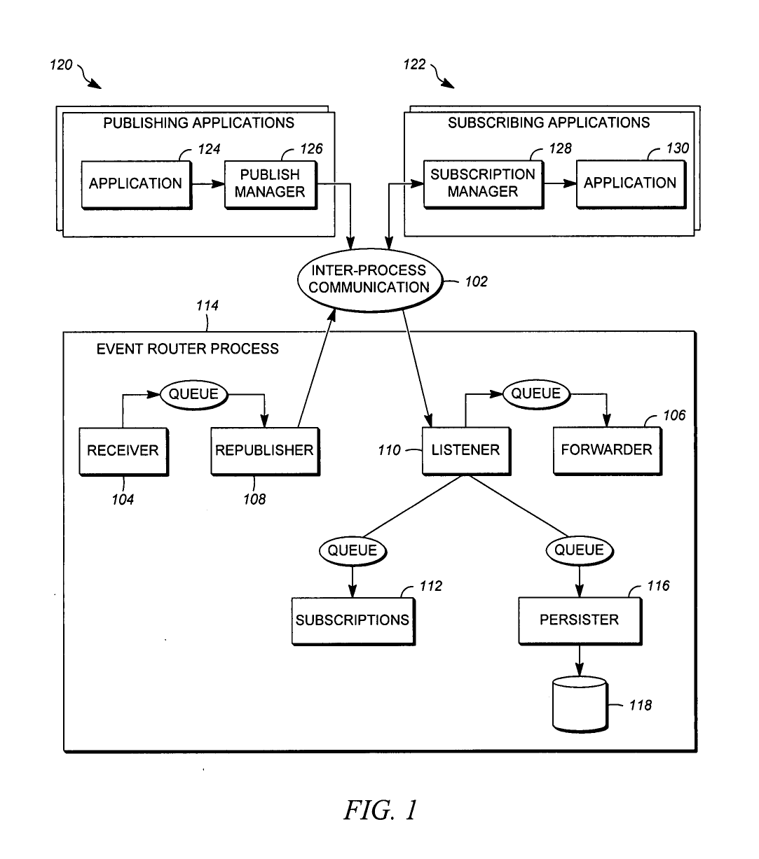

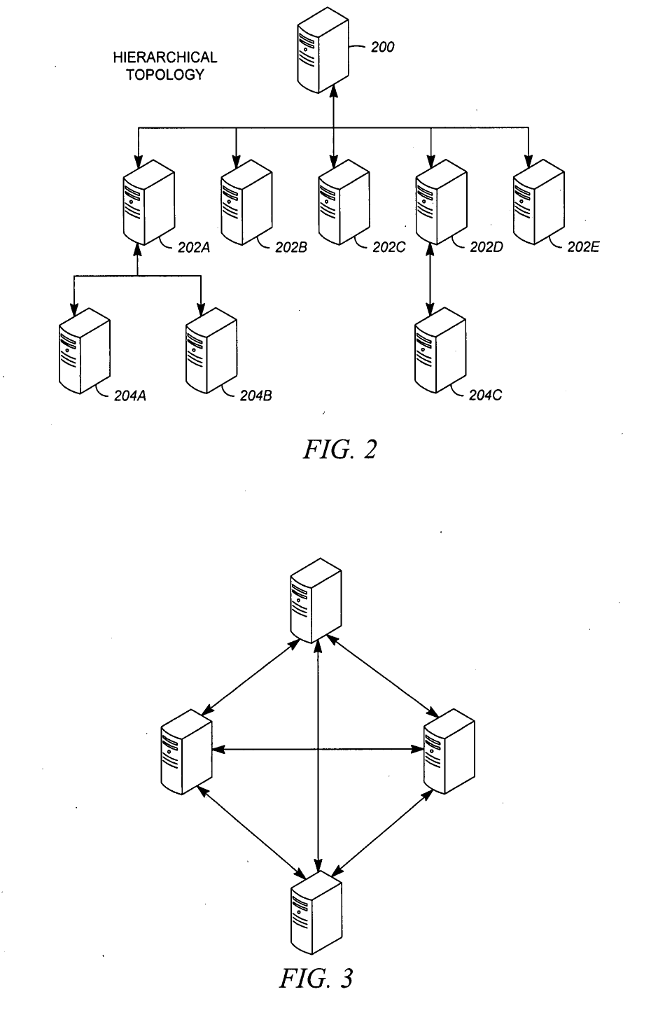

In describing the embodiments, it is pedagogically useful to refer back and forth to two drawings, one illustrating a system of modules running on a single machine (FIG. 1), and another illustrating a connected topology of such machines (FIG. 2).

A system of modules on a single machine according to an embodiment of the present invention is illustrated in FIG. 1. The modules represented in FIG. I may also be referred to as processes or components. There are three main modules: Publishing Applications 120, Subscribing Applications 122, and Event Router Process 114. These three modules communicate by Inter-Process Communication 102, so that various modules have shared access to publication events and subscription events. Shared memory is one example of an implementation of Inter-Process Communication 102. There are many forms of Inter-Process Communications of which brokers, named pipes, and TCP/IP (Transmission Control Protocol/Internet Protocol) are other examples, to name a few, but in general these will be slower than shared memory.

A machine may be a general purpose or special purpose computer system. A router is an example of a machine, in which a computer system is optimized in some sense for routing. Because routing tables are maintained on a machine (to be discussed later), it is sometimes convenient to refer to a machine as a router, but it should be understood that this is done merely for convenience, and that a machine may or may not be optimized for routing.

The various modules illustrated in FIG. 1 may be software modules (processes), or hardware components. In practice, modules within Publishing Applications 120 and Subscribing Applications 122 are generally implemented as software processes, and most sub-modules within Event Router Process 114 are implemented as software modules. Memory 118 within Event Router Process 114, and the queues identified in Event Router Process 114, may be viewed as hardware modules. Inter-Process Communication 102 may be viewed as one or more software modules if implemented as a broker or software pipe, but it should be viewed as a hardware module if implemented as shared memory.

Event Router Process 114 includes a number of modules: Receiver 104, Forwarder 106, Republisher 108, Listener 110, Subscriptions 112, Persister 116, and Memory 118. Some embodiments may not include Persister 116 and Memory 118. There are also queues, as indicated in FIG. 1, for buffering communication between various pairs of these modules.

Event Router Process 114 is responsible for routing events, whether subscription events or published events, where published events are routed according to routing tables managed by Subscriptions 112, and subscription events are routed according to a subscription process, unless the subscription event is marked local-only. As implied by the previous sentence, the term “event” may be used to mean either a published event or a subscription event, whereas in the Background, the term “event” was used to denote the actual event that triggers the publication of a published event. In the course of describing the embodiments, the term “event” may be used to mean a published event or a subscription event. It will be clear from context how the term “event” should be interpreted.

Receiver 104 and Forwarder 106 are the communication interfaces to other machines (e.g., routers) in communication with the machine of FIG. 1. These other machines are not shown in FIG. 1, but will be discussed with respect to FIG. 2. When Receiver 104 receives an event, whether a published event or a subscription event, it hands off the event to Republisher 108 to publish the event on the machine. In this context, publishing an event on a machine refers to making the event available to other modules on the machine by using Inter-Process Communication 102. This will be referred to as publishing locally. If Inter-Process Communication 102 is implemented as shared memory, then publishing locally involves placing the event into shared memory. Once published locally, Listener 110 receives the event from Inter-Process Communication 102 and makes the event available to other modules, such as Forwarder 106, Subscriptions 112, or Persister 116, depending upon the type of event. This will be described in more detail later.

FIG. 2 illustrates a network of machines configured as a hierarchical topology of machines. Referring, for convenience, to these machines as routers, each router in FIG. 2 may be considered an instance of an embodiment described with respect to FIG. 1. The routers in FIG. 2 may be classified as parents and children. For example, router 200 is a parent to routers 202A through 202E. Router 202A is both a child to router 200 and a parent to routers 204A and 204B. Router 202D is both a child to router 200 and a parent to router 204C. Continuing in this manner, commonly used terms denoting family relationships may be applied to the routers of FIG. 2. For example, routers 202A through 202E may be termed siblings with respect to each other, and so forth. Each router knows who its parent is, and each parent learns about its children as they connect. That is, a router maintains a table indentifying its parent and its children, if any.

The lines connecting the various routers in FIG. 2 represent communication channels. These communication channels may be within a single LAN (Local Area Network), or may span more than one LAN. That is, some (or all) of the routers in FIG. 2 may not be in close physical proximity to each other, and may belong to different networks.

Various protocols may be used for the communication channels, and may represent a connection oriented paradigm, or a connectionless oriented paradigm. For example, IP/UDP (Internet Protocol/User Datagram Protocol) or TCP/IP may be used. In setting up a communication channel, sockets (e.g., UDP or TCP sockets) are set up between the communicating routers. For some embodiments, these sockets are kept open for the duration of the publish-subscribe event process to improve performance and reduce latency. Generally, a router is said to be connected to another router if there is a communication channel set up between the two routers.

Every event has a unique identifier, which may be termed an event type. An event type is a GUID (Globally Unique Identifier) that allows any creator of an event, whether a published event or a subscription event, to define their own event type without conflicting with event types created by other publishers or subscribers. A subscription event also has a separate property to define the event type to which it subscribes. Such an event type will be referred to as a subscribed-to event type.

Subscriptions are handled by propagating subscription events throughout the topology of routers. Routing tables are built and maintained dynamically as subscription events are received. Once a subscription event is published locally, Listener 110 forwards the subscription event to Subscriptions 112 to update the routing table stored in the local machine by associating the subscribed-to event type with the communication channel (e.g., TCP socket) of the router from which it came.

For example, if router 202A receives a subscription event from one of its children, say router 204B, then Subscriptions 112 within router 202A updates the routing table in router 202A to associate the GUID of the published event that the received subscription event is subscribing to (the subscribed-to event type or GUID) with the TCP socket by which router 204B communicates with router 202A. Because router 202A also has a parent, Listener 110 hands off the subscription event to Forwarder 106 to send the subscription event to its parent, router 200. Router 200 then handles the subscription event in similar fashion, updating its routing table to associate the subscribed-to GUID with the TCP socket connected to the child that sent it the subscription event, namely router 202A. Note that other embodiments may utilize a protocol other than TCP.

Subscription events propagate from child to parent, and from parent to other children. When router 202A receives a subscription event from its child, router 204B, it also sends the subscription event to its other child, router 204A, so that router 204A can update its routing table. When router 200 receives the subscription event from its child, router 202A, it also sends the subscription event to its other children, routers 202B through 202E. Router 202D, because it is a parent, also sends the subscription event to its child, router 204C. More generally stated, each router that receives a subscription event from its child sends that subscription event to its other children, if any, as well as to its parent if it has one; and each router that receives a subscription event from its parent also sends that subscription event to all of its children, if any. In this way, routing tables in both parents and children are updated.

When a published event is received and has been published locally, Event Router Process 114 routes this published event according its routing table, but does not send the published event back to the router from which it came. In this way, published events are routed to the appropriate subscribers according to the routing tables created during the subscription process.

Returning to FIG. 1, Publishing Applications 120 may include more than one publishing application, indicated by an overlay of two boxes as shown in FIG. 1. For simplicity, an overlay of only two boxes is shown, and only one box is shown in its entirety. This box includes a single publishing application, labeled as Application 124 but referred to as Publishing Application 124, and also includes Publish Manager 126. Similarly, Subscribing Applications 122 may include more than one subscribing application, but for simplicity, only one box is shown in its entirety with a single subscribing application, labeled as Application 130 but referred to as Subscribing Application 130, and the box also includes Subscription Manager 128.

To initiate a publication (that is, published event) on a router, Publication Application 124 uses Publish Manager 126 to publish locally the published event. (That is, the published event is made available to other modules on the router by using Inter-Process Communication 102.) If Listener 110 determines that the published event has an event type (GUID) in the routing table managed by Subscriptions 112, then Forwarder 106 sends the published event to those TCP sockets (or other types of sockets if a protocol other than TCP is used) in the routing table that match the event type.

Listener 110 may also make available events (published events or subscription events) to Persister 116 for the purpose of maintaining various logs, where such logs are stored in Memory 118. As mentioned previously, some embodiments may not utilize Persister 116 and Memory 118, so that logs are not kept for some embodiments.

Subscription Manager 128 keeps track of event types of interest to Subscribing Application 130. When a published event is published locally, whether by Publish Manager 126 or Republisher 108, Subscription Manager 128 hands off to Subscribing Application 130 the event if it has been subscribed to by Subscribing Application 130.

To initiate a subscription process, that is, when there is a new subscriber, Subscription Manager 128 causes an instantiation of a Publish Manager, and this instantiation publishes locally the subscription event by using Inter-Process Communication 102. If the newly initiated subscription event is not marked as local-only, then Event Router Process 114 will route the subscription event to the parent, if there is one, but also to all children, if any. Thereafter, the subscription process follows that of the previous discussion with respect to routers that receive subscription events from other routers.

From the above description, it is seen that by using Inter-Process Communication 102 in a router to publish locally, such as for example by putting a published event into physical memory that is shared by the various modules, subscription applications running on the router will be able to retrieve those published events to which they have subscribed to, and published events will also be sent to other routers according to the routing table kept in the router, so that other subscribing applications running on other routers may have access to the published events.

Other types of router topologies may be used. One such example is a completely connected mesh in which each router has a network connection with all other routers. A simple example is illustrated in FIG. 3, showing four routers, each router with connections to all other routers. A reliable IP (Internet Protocol) multicast protocol may be implemented so that each router reliably broadcasts to all other routers on the mesh. Updating the routing tables during a subscription process is simply done by sending out a received subscription event over all router connections, except to the router from which it came. If the subscription event is initiated at a router, then it is forwarded over all other router connections, unless it is a local-only subscription event. Because the mesh is completely connected, subscription events reach all the routers in just one hop. Other embodiments may have different topologies.

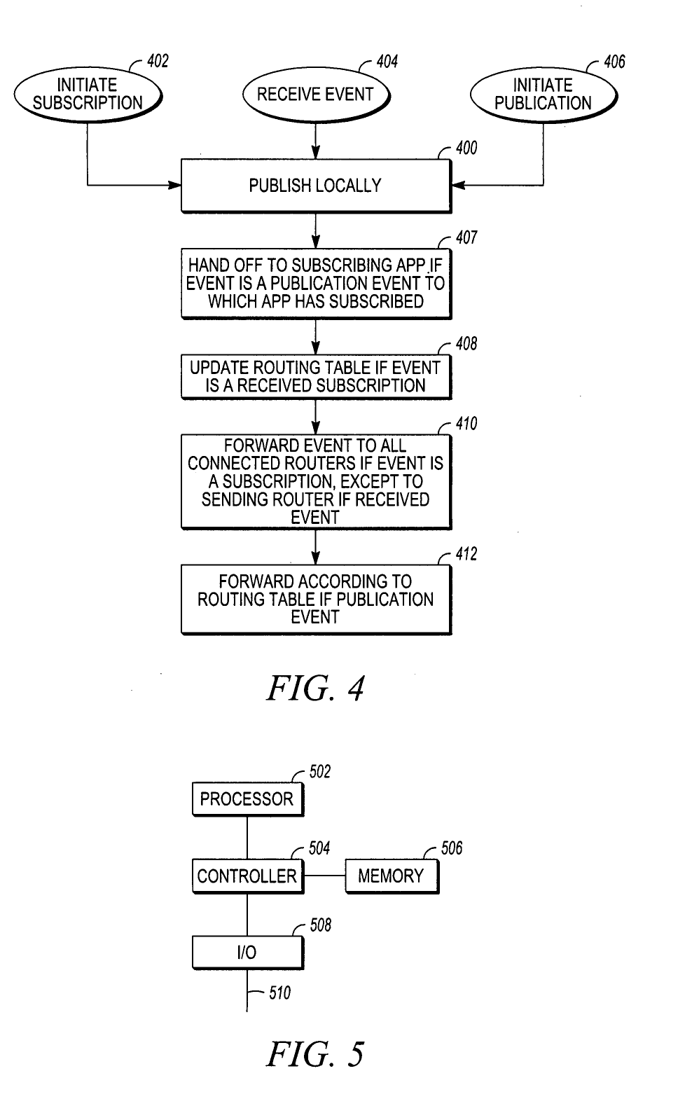

The above description regarding the routing process may be summarized in the flow diagram of FIG. 4. An event may arise by being a subscription event initiated at the router (block 402), being an event (published event or subscription event) received at the router from another router (block 404), or being a published event initiated at the router (block 406). In block 400, the event is published locally by using Inter-Process Communication 102, which may be implemented as shared memory, for example. At that point, several things may happen, indicated by blocks 407 through 412. The display of these remaining blocks in a sequential fashion does not imply that they are performed in any particular sequential order. Some, or all, of the processes indicated by these blocks may proceed in parallel. The particular sequential order illustrated in FIG. 4 was chosen merely for ease of description and illustration.

In block 407, Subscription Manager (128) listens to all published events, and any event that is subscribed to by a subscribing application is passed on to that subscribing application. In block 408, the routing table is updated (if needed) if the event is a received subscription event. In block 410, a subscription event is forwarded to all connected routers if it is not marked as local-only, except that a subscription event is not forwarded to the router that sent it. In block 412, a published event is forwarded according to the routing table.

FIG. 5 illustrates in simple fashion a portion of a computer system in which an embodiment may be instantiated. Functional unit 502 represents one or more processors. Controller 504 serves as an interface between Processor 502, Memory 506, and I/O (Input/Output) functional unit 508. Controller 504 is sometimes referred to as a chipset, or a hub. Some, or all, of the functionality of Controller 504 may be integrated with Processor 502. Memory 506 may represent a hierarchy of memory, perhaps including removable storage, and may be referred to in general as computer readable media. I/O functional unit 508 provides communication over Physical Link 510, so that events may be received from or sent to other computer systems (not shown). Physical Link 510 includes a physical communication link (or channel), which may for example be an optical link, a wireless link, or an electrical serial link, to name just a few examples.

Instructions stored in Memory (computer readable media) 506 cause the computer system of FIG. 5 to implement the previously described processes. For example, Event Router Process 114 may be implemented as an operating system service, that is, it loads during boot-up and runs in the background. Publish Manager 125 and Subscription Manager 128 may be class libraries.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims. Accordingly, various modifications may be made to the described embodiments without departing from the scope of the invention as claimed below.

What is claimed is:

1. A method comprising:
receiving at a machine a published event;
publishing locally in the machine the published event by an inter-process communication;
accessing the published event by a subscribing application running on the machine if the subscribing application subscribes to the published event; and
forwarding the published event according to a routing table stored in the machine.

2. The method as set forth in claim 1, wherein publishing locally in the machine the published event by the inter-process communication comprises placing the published event into a shared memory.

3. The method as set forth in claim 1, further comprising:
receiving at the machine a subscription event over a communication channel, the subscription event having a subscribed-to event type; and
managing the routing table in the machine so that the subscribed-to event type is associated with the communication channel over which the subscription event was received.

4. The method as set forth in claim 3, wherein the communication channel comprises a Transmission Control Protocol socket connection.

5. The method as set forth in claim 1, further comprising:
initiating a subscription event at the machine;
publishing locally in the machine the subscription event by the inter-process communication; and
forwarding the subscription event over all outgoing communication channels of the machine if the subscription event is not marked as local-only.

6. The method as set forth in claim 5, further comprising:
receiving at the machine a second subscription event over a communication channel, the second subscription event having a subscribed-to event type; and
managing the routing table in the machine so that the subscribed-to event type is associated with the communication channel over which the subscription event was received.

7. The method as set forth in claim 5, wherein publishing locally in the machine the subscription event by the inter-process communication comprises placing the subscription event into a shared memory

8. A method comprising:
receiving at a machine a subscription event over a communication channel; and
updating a routing table to associate the subscription event with the communication channel.

9. The method as set forth in claim 8, wherein the communication channel comprises a Transmission Control Protocol socket connection.

10. The method as set forth in claim 8, the subscription event having a subscribed-to event type, wherein when updating the routing table the subscribed-to event type is associated with the communication channel.

11. The method as set forth in claim 10, further comprising:
if a published event is received having an event type in the routing table, then forwarding the published event according to the routing table.

12. The method as set forth in claim 10, further comprising:
publishing locally in the machine a published event by an inter-process communication; and
accessing the published event by a subscription application that subscribes to the published event.

13. The method as set forth in claim 12, further comprising:
if the published event was received having an event type in the routing table, then forwarding the published event according to the routing table.

14. The method as set forth in claim 12, wherein publishing locally in the machine the published event by the inter-process communication comprises placing the published event into a shared memory

15. An article of manufacture comprising a computer readable media, which when read by a computer causes the computer to update a routing table to associate a received subscription event with a communication channel.

16. The article of manufacture as set forth in claim 15, the subscription event having an event type to which it subscribes to, the computer readable media further causing the computer to update the routing table to associate the event type to which it subscribes to with the communication channel.

17. The article of manufacture as set forth in claim 16, the computer readable media further causing the computer to forward a received published event according to the routing table if the received published event has an event type in the routing table.

18. The article of manufacture as set forth in claim 16, the computer readable media causing a subscription application running on the computer to access a received published event if the subscription application has subscribed to the published event.

19. The article of manufacture as set forth in claim 18, the computer readable media further causing the computer to forward the received published event according to the routing table if the received published event has an event type in the routing table.

20. The article of manufacture as set forth in claim 15, wherein the communication channel comprises a Transmission Control Protocol socket connection.
